(19) United States
(12) Patent Application Publication
(10) Pub. No.: US 2009/0138109 A1
(43) Pub. Date: May 28, 2009

(54) APPARATUS PROVIDING FUNCTION TO DELETE FILES AND METHOD FOR DELETING FILES THEREOF

(75) Inventor: Hyun-Jung Park, Seoul-si (KR)

Correspondence Address: BIRCH STEWART KOLASCH & BIRCH, PO BOX 747, FALLS CHURCH, VA, 22040-0747, US

(73) Assignee: LG Electronics Inc., Seoul City (KR)

(21) Appl. No.: 12/265,597

(22) Filed: Nov. 5, 2008

(30) Foreign Application Priority Data
Nov. 6, 2007 (KR) 10-2007-0112785

(51) Int. Cl. G06F 17/00

(52) U.S. Cl. 700/94

(57) ABSTRACT

A multimedia playing apparatus including a storage unit configured to store multi-media data files, and a control unit configured to determine whether each of the data files is playable or unplayable and to automatically delete unplayable data files.

### CROSS REFERENCE TO A RELATED APPLICATION

The present application is related to and claims priority to Korean patent application No. 10-2007-0112785, filed in Korea on Nov. 6, 2007, the entire contents of which are hereby incorporated by reference.

### BACKGROUND OF THE INVENTION

1. Field of the Invention

The present invention relates to an apparatus and a method for analyzing stored files and deleting files which are unplayable.

2. Description of the Related Art

Many portable devices now can play multi-media files such as MP3 files. The portable devices are also becoming smaller in size and able to store more and more files. Thus, a user often has several multiple media files on their personal portable device. Therefore, it is often time consuming and cumbersome to search through the several files stored on the device when the user wants to play a particular file.

### SUMMARY OF THE INVENTION

Accordingly, one object of the present invention is to address the above-noted and other drawbacks.

Another object of the present invention is to provide an apparatus and a method for automatically deleting unplayable files from a multi-media device.

To achieve this and other advantages and in accordance with the object of the present invention, as embodied and broadly described herein, the present invention provides in one aspect a multimedia playing apparatus including a storage unit configured to store multi-media data files, and a control unit configured to determine whether each of the data files is playable or unplayable and to automatically delete unplayable data files.

In another aspect, the present invention provides a method of controlling a multimedia playing apparatus, and which includes storing multi-media data files in a storage unit of the apparatus, determining whether each of the data files is playable or unplayable, and automatically deleting unplayable data files.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a conceptual view illustrating an audio file data format according to an embodiment of the present invention;

FIG. 2 is a block diagram illustrating an MP3 playing apparatus providing a file deleting function according to an embodiment of the present invention;

FIG. 3 is a flowchart illustrating a method of generating a play list of an MP3 playing apparatus according to an embodiment of the present invention;

FIG. 4 is a flowchart illustrating the step 320 in FIG. 3; and

FIG. 5 is a flowchart illustrating a method of generating a play list of an MP3 playing apparatus according to another embodiment of the present invention.

### DETAILED DESCRIPTION OF THE INVENTION

Reference will now be made in detail to the preferred embodiments of the present invention, examples of which are illustrated in the accompanying drawings.

MP3 players are very popular especially with the younger generation. Further, the MP3 players include a feature in which the user can connect to the Internet and download many different types of music or video files. However, because the user downloads so many different types of files, shares files with other users, etc., the user often has difficultly in easily searching and playing specific MP3 files.

Also, because the MP3 players are small in size, the amount of available memory is also limited. An embodiment of the present invention advantageously deletes unplayable data files without user intervention such that the memory of the player is free of unplayable data files. This also increases the available space on the memory of the player and makes it easier for the user to search for music to play on the player. That is, the unplayable data files are automatically deleted so the user does not have to include these files in a search process or playing process. Further, the MP3 player is described as an example only and other type of multimedia players are also applicable to the present invention.

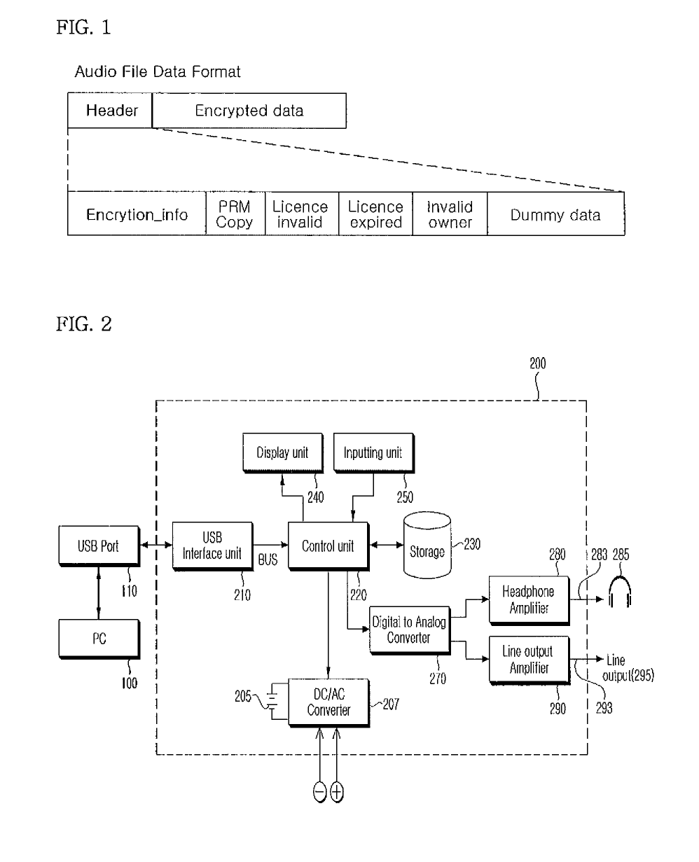

FIG. 1 is a conceptual view illustrating an audio file data format according to an embodiment of the present invention. As shown in FIG. 1, an audio data file (e.g. a DRM file according to an embodiment of the present invention) includes header information and encrypted data. As shown, the header information includes encryption information (Encryption_info) to decode the encrypted audio data, license invalid information (License_invalid) to indicate whether the audio data file has a license to play or to copy, license expired information (License_expired) to indicate whether the license of the audio data file has expired, license information (Invalid_owner) to indicate whether the apparatus has a license to play or to copy the audio data file, and dummy data.

Further, the MP3 player searches and reads the header information of each of audio data file and checks information included in the header information when a play command is detected. Then, the MP3 player decodes the audio data files based on the header information and plays the decoded audio data files. Also, according to an embodiment of the present invention, the MP3 player automatically deletes unplayable audio data files and rebuilds play lists from which the unplayable audio data files are excluded.

Next, FIG. 2 is a block diagram illustrating an MP3 playing apparatus 200 according to an embodiment of the present invention. In the example shown in FIG. 2 the MP3 player 200 is connected to a personal computer (PC) 100 through a USB port 110 such that audio data files can be downloaded from the PC 100.

In more detail, the audio data files are downloaded from the PC 100 to a storage unit 230 of the MP3 player 200 through the USB port 110 using an audio file managing application providing encoded audio data files according to a selected encoding format such as MP3 or MP3 pro. In addition, the storage unit 230 may be one of various storage devices such as an EEPROM (Electrically Erasable Programmable Read-Only Memory), a flash memory, or an external storage device.

As shown in FIG. 2, the MP3 200 also includes a digital-to-analog converter 270 configured to convert digital signals of the audio data files into analog signals. The digital-to-analog converter 270 also provides the converted analog signals to a headphone amplifier 280 and to a line output amplifier 290. The amplified signals by the headphone amplifier 280 and the line output amplifier 290 are also respectively provided to a headphone jack 283 and to a line output jack 293.

Further, the MP3 player 200 also includes an inputting unit 250 that the user can use to input commands and other information into the player 200. For example, the inputting unit 250 can include icons or buttons that the user can select to input various instructions and settings. The inputting unit 250 may also be configured as a keypad, touch pad, touch screen, etc. In addition, the MP3 player 200 includes a display unit 240 such as an LCD (Liquid Crystal Display). The display unit 240 may also comprise a touch screen that the user can touch to input information into the terminal.

In addition, the MP3 player 200 includes an interface unit 210 for interfacing with external devices and in particular the PC 100 via the USB port 110. A DC/AC converter 207 having a particular voltage value 205 is also provided such that the MP3 player can be connected to an external power source.

Further, as shown in FIG. 2, the MP3 player 200 also includes a control unit 220 controlling the overall operations of the MP3 player and decoding audio files. The control unit 220 may also include a ROMs (Read Only Memory) or RAMs (Random Access Memory) to store instruction sets and/or various programs for controlling the operations of the terminal.

Further, the control unit 220 executes various data processing functions (for example, decoding a currently played audio data file, controlling the volume, equalizing digital sounds and sampling) while an audio data file is being played. In addition, when the audio data files stored in the storage unit 230 are encrypted, the control unit 220 decodes the encrypted audio data files using decoding programs and at least one decoding key. The control unit 220 then provides the decoded audio data stream to the digital-to-analog converter 270 included in the MP3 player 200.

Further, according to one embodiment of the present invention, the control unit 220 accesses audio data files stored in the storage unit 230 and determines whether the audio data files is a playable file, when the control unit 220 receives a driving signal or play command for playing a file on the MP3 player 200. That is, the control unit 220 determines whether a file type of each of the audio data files is a file type which the MP3 player can support (for example, an MP3 player can support the MP3 file type, but may not be able to support a “*.wav” or a “*.asf” file type) and then determines whether the header information of each of the audio data files is damaged.

In addition, if a file type can be supported, and the header information of the audio data file is not damaged, the control unit 220 determines whether the audio data file is a DRM (Digital Right Management) file based on the header information. If the audio data file is a DRM file, the control unit 220 determines whether or not the audio data file is playable by comparing the header information such as the license invalid information, the license expired information, and the license information with current system states.

Further, the control unit 220 also controls a display unit 240 to display an error message regarding any unplayable audio data files and deletes the unplayable audio data files from the storage unit 230 and from a play list when there is at least one unplayable audio data file in the storage unit 230 according to the determination as to whether or not each of the audio data files is playable.

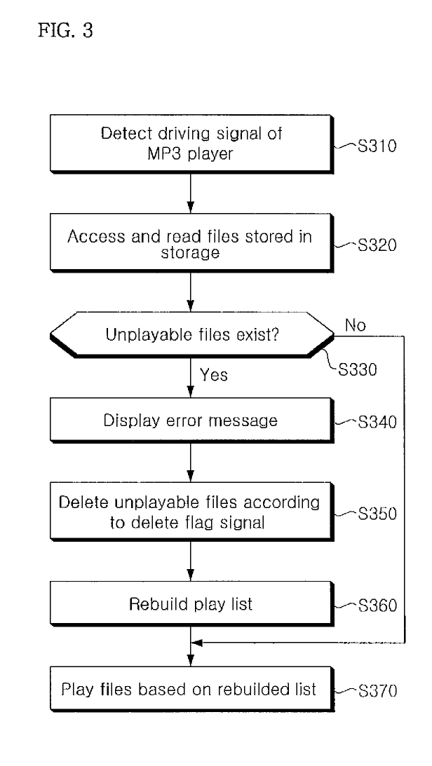

Next, FIG. 3 is a flowchart illustrating a method of generating a play list in an MP3 playing apparatus according to an embodiment of the present invention. This embodiment will be described based on the assumption that the MP3 player 200 has already downloaded audio data files from the PC 100. As shown in FIG. 3, the control unit 220 of the MP3 player 200 detects a driving signal indicating an audio data file is to be played (S310). For example, the user can press a play button on the MP3 player to play a particular MP3 file.

Then, the control unit 220 reads all of the audio data files stored in the storage unit 230 to determine whether the audio data files are playable (S320). Further, as mentioned above, the audio data files may include encrypted data, and in this instance, the header information of the audio data files includes encryption information (Encryption_info) that can be used to decode encrypted audio data. The header information also includes license invalid information (License_invalid) to indicate whether the audio data file has a license to play or to copy, license expired information (License_expired) to indicate whether the license of the audio data file has expired, license information (Invalid_owner) to indicate whether the apparatus has a license to play or to copy the audio data file, and dummy data.

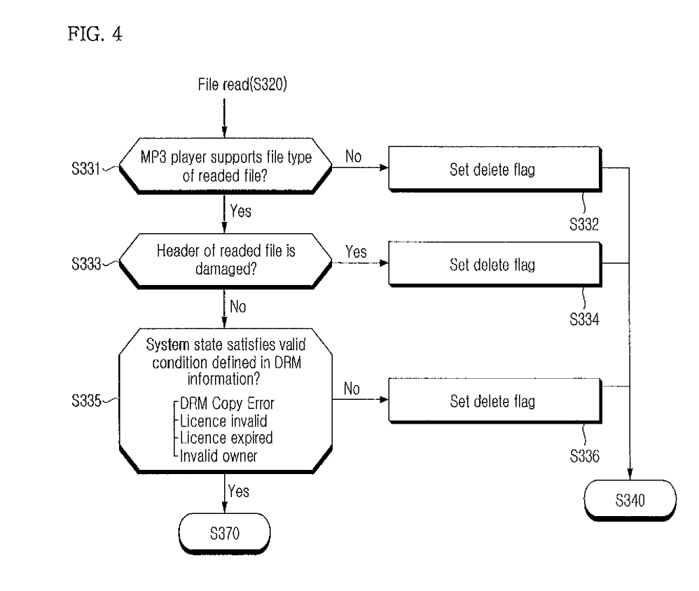

FIG. 4 is a flowchart illustrating in more detail the operations of determining whether each of the audio data files stored in the storage unit 320 is playable on the MP3 player. As shown in FIG. 4, the control unit 220 first determines whether the file type of each of the audio data files is supported by the MP3 player (S331). For example, if the MP3 player supports only an MP3 file type, the control unit 220 determines that “*.wav” files and “.asf” files are unplayable.

If the control unit 220 determines that the file type of one of the audio data files is not supported by the MP3 player (No in S331), the control unit 220 writes a delete flag indicating that the audio data file is unplayable on a certain portion of the audio data file or on a certain portion of an audio data file database storing the audio data files (S332). Further, if the control 220 determines that a file type of one of the audio data files is supported by the MP3 player (Yes in S331), the control unit 220 accesses the header information of the audio data file and determines whether the header information is damaged (S333).

If the header information is damaged (Yes in S333), the control unit 220 determines that the audio data file is unplayable and writes a delete flag indicating that the audio data files is unplayable on a certain portion of the audio data file or on a certain portion of an audio data file database storing the audio data files (S334). On the other hand, if the header information is not damaged (No in S333), the control unit 220 determines whether the audio data file has DRM (Digital Rights Management) information, and then reads the DRM information (S335).

In more detail, the control unit 220 reads the license invalid information, the license expired information, and the license information, and determines whether the current states of the MP3 player satisfy the condition defined by the information so that the control unit 220 can determine whether the audio data file can be played on the MP3 player. Further, if the current states of the MP3 player satisfy the condition defined by the license expired information, the license invalid information and the license information (Yes in S335), the control unit 220 determines that the audio data file is playable and plays the file (S370).

On the other hand, if the current states of the MP3 player don't satisfy the condition defined by the license expired information, the license invalid information and the license information of the audio data file (No in S335), the control unit 220 determines that the audio data file is unplayable, and writes a delete flag indicating that the audio data file is unplayable on a certain portion of the audio data file or on a certain portion of an audio data file database storing the audio data files (S336). In addition, the control unit 220 may also write an error value indicating the reason why the audio data file is unplayable together with the delete flag.

Then, returning to FIG. 3, the control unit 220 accesses the database and reads the delete flags to determine if there are any unplayable files (S330). When, there are unplayable files (Yes in S330), the control unit 220 controls the display unit 240 to display an error message regarding audio data files that have the set delete flag. Further, the error message includes error values regarding each of audio data files having the set delete flag. Then, the control unit 220 deletes the unplayable audio data files having the set delete flag (S350), and rebuilds a play list excluded the deleted audio data files (S360). In addition, the control unit 220 plays audio data files based on the rebuilt play list (S370).

Next, a method of deleting files according to another embodiment of the present invention will be described. One difference between the embodiment described above and this embodiment is that unplayable audio data files are deleted from the storage unit 230 when a user selects ‘A function of deleting files’ on the MP3 player.

Thus, the user can use the inputting unit 250 to execute the function of deleting files. The MP3 may also include an external switch that the user can select to switch between automatically deleting files or not automatically deleting files. The control unit 220 then only deletes the unplayable files when the user has selected the function of deleting files.

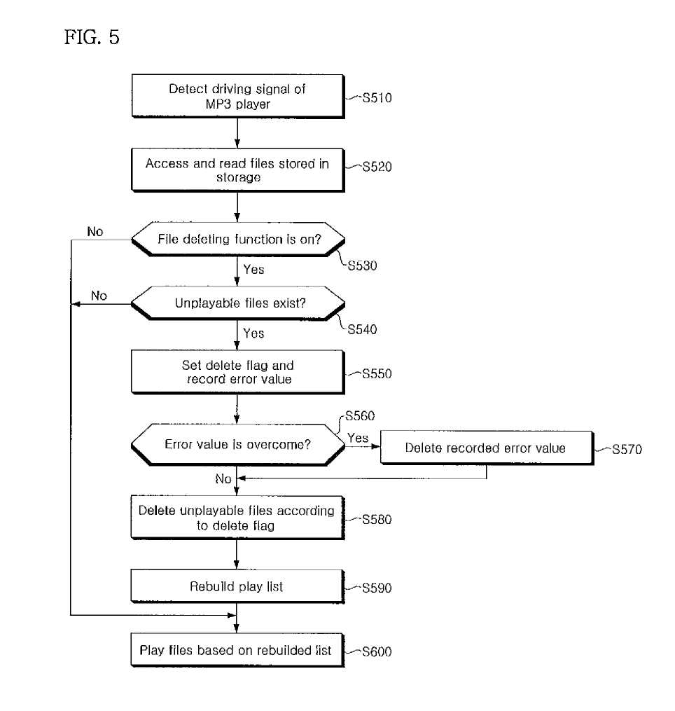

In addition, the control unit 220 can delete the unplayable audio data files after the reading an error value of each unplayable audio data file, determine whether the error value of each of the unplayable audio data files can be overcome, and then recover the error, even if the function of deleting files is on in the MP3 player. FIG. 5 illustrates these features in more detail.

As shown in FIG. 5, the control unit 220 of the MP3 player 200 detects a driving signal for playing an audio data file (S510). Then, the control unit 220 reads each of the audio data files stored in the storage unit 230 sequentially to determine whether the audio data files are playable in the MP3 player (S520). The control unit 220 also determines whether the function of automatically deleting files is set in the MP3 player (S530).

If the auto delete function is set (Yes in S530), the control unit 220 determines whether the audio data files stored in the storage unit 230 are unplayable. For example, and as discussed above, the control unit 220 can determine whether a file type of each audio data files is supported by the MP3 player or whether header information of each audio data files is damaged. The control unit 220 also reads the license expired information, the license invalid information and the license information from each audio data file and determines whether the current states of the MP3 player satisfy the conditions defined by the information, if the each of the audio data files is a DRM file (S540). In this instance, the control unit 220 determines that the each of the audio data files is playable if the conditions are satisfied.

If at least one unplayable audio data file exists (Yes in S540), the control unit 220 writes a delete flag indicating that the audio data file is unplayable on a certain portion of the audio data file or on a certain portion of an audio data file database storing audio data files (S550). As discussed above, the control unit 220 may write an error value indicating the reason why the audio data file is unplayable together with the delete flag.

The control unit 220 then determines whether an error of the audio data file including the delete flag can be overcome, before deleting the unplayable audio data file (S560). If the error can be overcome (Yes in S560), the control unit 220 deletes the delete flag of the audio data file (S570). The control unit 220 then accesses the audio data file database and reads the delete flag for the unplayable audio data file.

After the delete flag has been deleted or the error flag can not be deleted, the control unit 220 deletes the audio data files having the set delete flag (S580) and rebuilds the play list (S590). In addition, the control unit 220 plays audio data files based on the rebuilt play list (S600).

Thus, the present invention provides several advantages. First, because unplayable multi-media files are automatically deleted, and play lists are generated excluding the unplayable files in the apparatus, the user can more easily use the apparatus without being concerned for files that are corrupted and unplayable. Further, because the unplayable multi-media files are deleted, the storage space on the apparatus is optimized.

In addition, the above various embodiments may be implemented in a computer-readable medium using, for example, computer software, hardware, or some combination thereof. For a hardware implementation, the embodiments described above may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, the memory 160), and executed by a controller or processor (for example, the controller 180).

In addition, the mobile terminal 100 may be implemented in a variety of different configurations. Examples of such configurations include a folder-type, slide-type, bar-type, rotational-type, swing-type and combinations thereof.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A multimedia playing apparatus, comprising:
a storage unit configured to store multi-media data files; and
a control unit configured to determine whether each of the data files is playable or unplayable and to automatically delete unplayable data files.

2. The apparatus of claim 1, wherein the data files include DRM (digital rights management) information.

3. The apparatus of claim 2, wherein the DRM information includes license expired information, invalid owner information and license invalid information.

4. The apparatus of claim 3, wherein the control unit is further configured to determine whether a file type of each of the data files is supported by the apparatus and to determine that a data file is an unplayable data file, if a file type of the data file is not supported by the apparatus.

5. The apparatus of claim 3, wherein the control unit is further configured to determine whether a header of each data file is damaged if a file type of each data file is supported by the apparatus, and to determine a data file is an unplayable data file when the header of the data file is damaged.

6. The apparatus of claim 3, wherein the control unit is further configured to access a header of each data file to determine whether a current state of the apparatus satisfies valid conditions defined by the DRM information included in the header, and to determines a data file to be a playable data file if the current state of the apparatus satisfies the valid conditions defined by the DRM information included in the header of the data file.

7. The apparatus of claim 1, wherein the control unit is further configured to output an error message for a determined unplayable data file.

8. The apparatus of claim 1, wherein the controller is further configured to determine if an error causing the data file to be unplayable can be repaired and to repair the error if the error can be repaired.

9. The apparatus of claim 1, wherein the control unit automatically deletes unplayable files stored in the storage unit without user intervention.

10. A method of controlling a multimedia playing apparatus, the method comprising:
storing multi-media data files in a storage unit of the apparatus;
determining whether each of the data files is playable or unplayable; and
automatically deleting unplayable files.

11. The method of claim 10, wherein the data files include DRM (digital rights management) information.

12. The method of claim 11, wherein the DRM information includes license expired information, invalid owner information and license invalid information.

13. The method of claim 12, further comprising:
determining whether a file type of each of the data files is supported by the apparatus; and
determining that a data file is an unplayable data file, if a file type of the data file is not supported by the apparatus.

14. The method of claim 12, further comprising:
determining whether a header of each data file is damaged if a file type of each data file is supported by the apparatus; and
determining a data file is an unplayable data file when the header of the data file is damaged.

15. The method of claim 12, further comprising:
accessing a header of each data file to determine whether a current state of the apparatus satisfies valid conditions defined by the DRM information included in the header; and
determining a data file to be a playable data file if the current state of the apparatus satisfies the valid conditions defined by the DRM information included in the header of the data file.

16. The method of claim 10, further comprising:
outputting an error message for a determined unplayable data file.

17. The method of claim 10, further comprising:
determining if an error causing the data file to be unplayable can be repaired and to repair the error if the error can be repaired.

18. The method of claim 10, wherein the deleting step automatically deletes unplayable files stored in the storage unit without user intervention.
